(19) United States
(12) Patent Application Publication
(10) Pub. No.: US 2004/0059703 A1
(43) Pub. Date: Mar. 25, 2004

(54) Cascading behavior of package generation/installation based on variable parameters

(76) Inventors: Jerry Chappell, Nepean (CA); Peter Van Der Veen, Kanata (CA)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/252,095

(22) Filed: Sep. 23, 2002

(51) Int. Cl. G06F 7/00

(52) U.S. Cl. 707/1

(57) ABSTRACT

The present invention relates generally to computer systems, and more particularly relates to a method and system for automatically installing software applications in a computer environment. The installation of new software packages or upgrading of existing packages often requires a great deal of data to be transferred, copied, decompressed and installed, consuming valuable communication bandwidth, storage space and processing power. The invention greatly reduces the demand on system resources by: identifying the files desired to be downloaded and installed; sorting these identified files into parameter-specific and parameter-independent groups; and generating a separate package each of the separate groups of identified files. In this way, separate parameter-specific and parameter-independent software packages are generated, so only the necessary software packages need to be processed to install new software, or upgrade an existing software package.

The present invention relates generally to computer systems, and more particularly relates to a method and system for automatically installing software applications in a computer environment.

### BACKGROUND OF THE INVENTION

Computer systems have become pervasive in the industrialized world. Personal computers (PCs) now sit on most desk tops, and cash registers have been replaced with point of sale terminals that are interconnected in a local or even a wide area network. Set top boxes are now being used to vastly expand the programming and functionality once offered to television viewers, and many other communication and household devices are now becoming computer and software controlled.

Maintaining and installing software applications on such systems has always been a problem. Users may wish to install new software applications, or upgrade existing applications to newer versions. As well, upgrading one application may require that other applications also be installed or upgraded because of interactions between them.

Even by itself, a software application may be much more complex than a single executable file. The typical software application, for example, may require the installation of many data, binary, text and executable files. It may also require that certain scripts, programs or software agents be run to install the software application. In the past, the installation of a third party software application would generally be performed in the following manner:

1. loading the software onto the target computer, either by copying the content of a diskette to a hard drive or downloading the software to a hard drive over some communication medium;

2. unpacking the software from its distribution format, which may be compressed or uncompressed;

3. locating and reviewing a file outlining the installation instructions, often stored as a “readme.txt” file;

4. installing the software, which may include steps such as:

a. creating the necessary directories and sub-directories on the target system;

b. installing software patches;

c. if the software was distributed in a source code format, compiling the source code into executable code;

d. copying files to the necessary directories and sub-directory locations; and

e. configuring the software code to the target computer; and finally,

5. testing the installed software.

Clearly, this process required a great deal of time, effort and possibly technical skill, on behalf of the end user. Because it would be impossible for the software developers to anticipate every conceivable circumstance that the end user might encounter, the installation instructions might be incomplete, making it very difficult for the end user to install the application correctly.

In recent years, the provisioning of such software systems has been simplified by the use of software “packages”. Software packages are single files which include all of the necessary software and data files, and their associated installation components. Each package is generally accompanied by a manifest which outlines: the name of package, the destination, the files contained in the package and any relevant attributes of these files. These software packages are tailored for a particular platform and are essentially self-executing, with little, if any, input required by the end user. Software packages therefore do not require the end user to understand the process involved in decompressing, compiling or installing software.

While this approach does improve the installation efficiency and reliability, many problems remain, for example, many redundant files are often stored on the end user's system if more than one related package is installed. In other cases, generic software packages are generated which include files for different platforms while all of the files are stored on the end user's system, only a small number of them can actually be used. In either case, there will be numerous components that will never be used by the core program. These unnecessary files waste processor time to carry out the file transferring, copying, decompressing and installing operations, waste communication bandwidth, and waste valuable storage space on both the source and destination computers or servers. Thus, it is desirable to save system resources by installing only those software components that are needed.

Hence, there is a need for an improved system and method of installing computer files and applications for computer networks and devices. Such computer networks and devices may include personal computers, laptop computers, terminals, servers, mainframes, scanners, printers, data storage units, communication devices, personal digital assistants, Internet ready cellular telephones, hardwired telephones, and television set top boxes. The proliferation of computerized appliances and computer controlled devices makes the need for such an improved system and method even greater as these devices could potentially run on different platforms and require different binary formats of the same files.

### SUMMARY OF THE INVENTION

It is therefore an object of the invention to provide a novel method and system of software file management which obviates or mitigates at least one of the disadvantages of the prior art.

One aspect of the invention is broadly defined as a method of preparing files for downloading and installation, comprising the steps of: identifying the files desired to be downloaded and installed; sorting the identified files into two or more groups, at least one of the groups of files containing files which are common to more than one application, and at least one of the groups of files containing files which are not common to more than one application; and generating separate packages for the first and second groups of files.

### BRIEF DESCRIPTION OF THE DRAWINGS

These and other features of the invention will become more apparent from the following description in which reference is made to the appended drawings in which:

FIG. 1 presents a flow chart of a method of generating software packages in a broad embodiment of the invention;

FIGS. 2A and 2B present a flow chart of a method of generating software packages in a preferred embodiment of the invention;

FIG. 3 presents a block diagram of an exemplary file structure for packaging files, in an embodiment of the invention;

FIGS. 4A through 4C present coding for an exemplary package manifest file, in an embodiment of the invention;

FIG. 5 presents a flow chart of a method of posing questions and receiving responses in a preferred embodiment of the invention;

FIG. 6 presents a flow chart of a method of sorting files and generating separate packages in a preferred embodiment of the invention;

FIG. 7 presents a flow chart of a method of establishing dependencies in a preferred embodiment of the invention;

FIGS. 8A, 8B, 8C and 8D presents coding for an exemplary package generation file, in an embodiment of the invention; and

FIG. 9 presents a flow chart of a method of installing software packages in a preferred embodiment of the invention.

### DESCRIPTION OF THE INVENTION

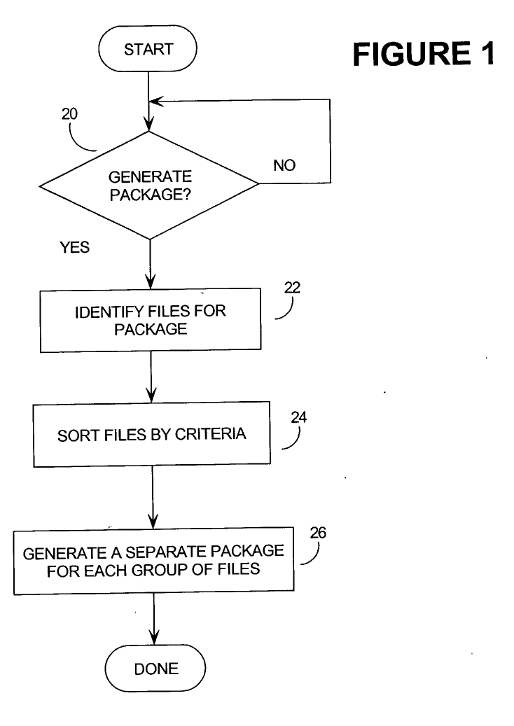

A method which addresses the objects outlined above, is presented in the flow chart in FIG. 1. Fundamentally, the algorithm described by this figure prepares two or more software installation packages for each individual application, rather than the single software installation package which would be generated by prior art methods. The files in the two or more packages are organized so that common files are separated from files which are specific to a particular application, platform, version, processor, or other parameter. Thus, it is not necessary to download and install all of the files one normally would, when installing additional software applications.

The method presented in FIG. 1 will typically be performed by a software routine which is referred to herein as a “Packager” utility. Describing this method in terms of discrete steps, the method begins with control sitting in a loop 20 until a “generate package” instruction is received. When such an instruction is received, control passes to step 22, where the files and directives required for the new software package are identified. These files and directives are then sorted into groups in accordance with the desired parameters (for example, separating platform-specific files from non-platform specific files) at step 24.

At step 26, these separate groups of files are then assembled into separate packages, and the targeted software application is now available for downloading, storage, installation, transmission or other handling.

The routine presented in FIG. 1 is greatly simplified in the interest of making it easy to understand. A real implementation of the invention may be considerably more complex, though the added complexity is within the ability of a skilled technician and will vary with the platform and particular application. For example, in a personal computer application, the monitoring of instructions per step 20 would not generally exist as a simple loop, but would be effected in the manner of the operating system the invention is being applied to.

As noted in the Background above, software packages and techniques for generating them are known in the art, though they generate a single compressed file package which stores everything that the targeted software application requires. Thus, many of the operations and details of implementing the invention, would already be known to one skilled in the art.

The identification of the files necessary for a given software package at step 22, can be done in a number of manners. Typically, the end user generating the package will place all of the necessary files in a single directory, so all that is necessary is to identify the targeted directory to the Packager routine, and it will assume that all files in the directory should be placed in the package. Other techniques could also be used such as: identifying each desired file, identifying a group of directories, identifying file libraries or identifying interdependencies between applications and routines. As will be described in greater detail, these files may include the main executable code, all support files, licenses, scripts and HTML web pages.

The manner in which the targeted files are sorted at step 24 will depend on the criteria being used to sort them. As noted above, the files typically will be separated by application, platform, version or processor, though other criteria could be used. The files for a certain category can be sorted manually (by the end user), or automatically, by considering the file extension, the header on each file or a similar indicator. In a Unix or Linux environment, for example, file headers typically follow the ELF (executable and linking format) standard, though other standards may also be used. Among other things, the file header provides information which identifies the type of file and the platform for which it is intended. The process of analysing and sorting files will be described in greater detail with respect to the preferred embodiment.

Once the files have been sorted, separate packages can be generated for these groups at step 26, using techniques known in the art. These separate packages can then be stored in an accessible location so that they can be downloaded, installed or transmitted as required. These packages could, for example, be made available via Internet web sites; the Internet Server could support all parameters, and only send the data that a given user requires.

The specific implementation of these steps may vary with the platform and application, but such specifics would be clear to one skilled in the art in view of the teachings herein. As well, additional features such as compression, password protection, encryption, and business transactions could also be added.

Thus, if the criteria for separation of the files was the operating platform, the method of the invention would be configured to automatically detect the common software components and generate a “core” package (i.e. files which do not require a particular processor in order to be used are placed into the core package). If files are detected which do require a particular processor, a new package related to that processor alone will be created, or if it already exists, then the files are added to it.

In general, the method of the invention allows software packages to be organized into smaller units or multiple layers, allowing for more flexible file storage and handling, and more efficient use of system resources.

For example, if a computer system supports two or more platforms, then it would be desirable to download software applications and their components in platform-dependent and platform-independent packages. When an application is downloaded for a first platform, at least two packages would be required (one platform-dependent and one platform-independent), but when the same application is downloaded for a second platform, only one package would be necessary: the plafform-dependent package intended for the second platform. The platform-independent package is already in place and need not be re-installed. The files in the platform-independent package can be accessed during the installation of the package for the second platform, so that they seamlessly appear to be available.

Because it is unnecessary to download the redundant file package (referred to as the common or core files), less bandwidth is necessary, the software is downloaded faster, installed faster (because some of the files have already been uncompressed and installed on the system) and less storage capacity is required to store the software.

The invention may be described as “cascading behaviour” as packages may be organized into a number of layers, each layer being defined by a different parameter. For example, packages could be arranged by operating system, then platform, then version of the application. This results in a tree, or cascade, of software packages.

The method of the invention will become more clear from the detailed description which follows. Note that the invention provides many additional advantages, several of which are identified hereinafter.

### DETAILED DESCRIPTION OF PREFERRED EMBODIMENTS OF THE INVENTION

The preferred embodiment of the invention will now be described with respect to a particular application, specifically, to the preparation of software packages that can be downloaded from a server on the Internet, to an end user's personal computer (PC). Clearly though, the invention could be applied to any computing environment.

As noted in the Background, packages are used to keep all aspects of a product in one manageable file. Similar to a .tgz, this one file is a compressed version of all of the files that make up a given software product.

Packages generated by the invention, however, have additional elements beyond the standard “tar ball” that exists in the prior art. Packages in the manner of the invention also include a manifest which lists the contents of the package, and any support files used within the package, such as licenses, scripts, or HTML web pages. Since all of this information is packaged together, the Package Installer application of the invention can extract the required information to install a software product in an automated way.

There are two main software routines employed by the invention: the Package Builder (or simply, the Packager) and the Package Installer.

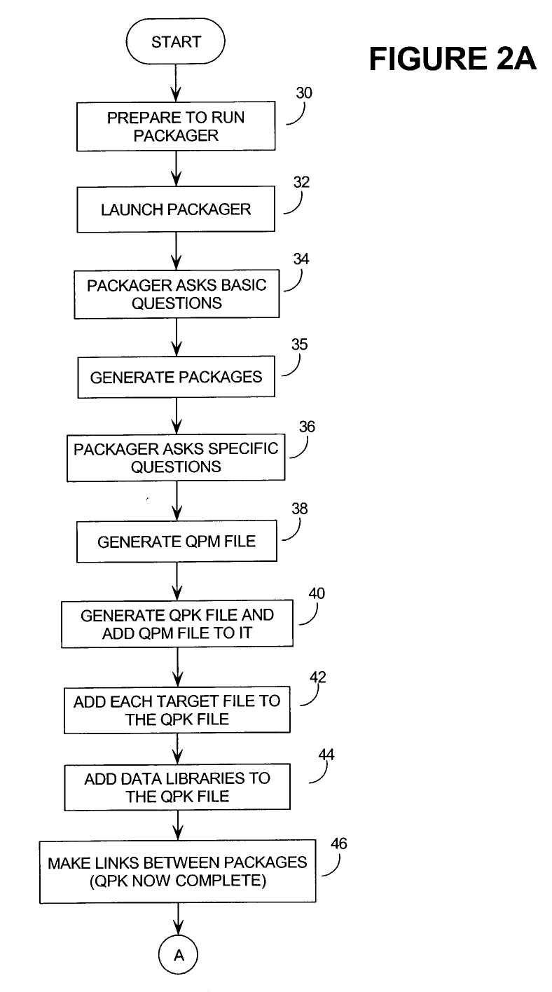

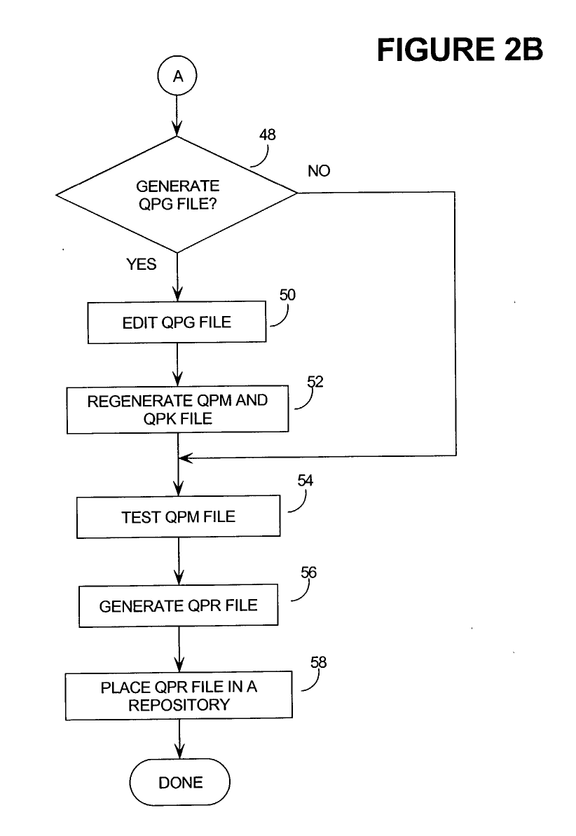

The Packager is used to generate software packages, and is preferably implemented in the manner presented in FIGS. 2 through 8. It can also be used to re-package existing packages to reflect updates in an application or to create patches from a previous package to a new one.

There are a large number of tags that make up a manifest file (referred to herein as a QPM file), so the Packager poses a correspondingly large number of questions in order to generate a package that is accurate and detailed. Note that the Packager was designed as a command-line utility so that once these questions have been answered, it is easy to pass the previous package as a command-line argument and bypass the questions the next time the utility is used. The invention could be applied to a graphical-based environment just as easily.

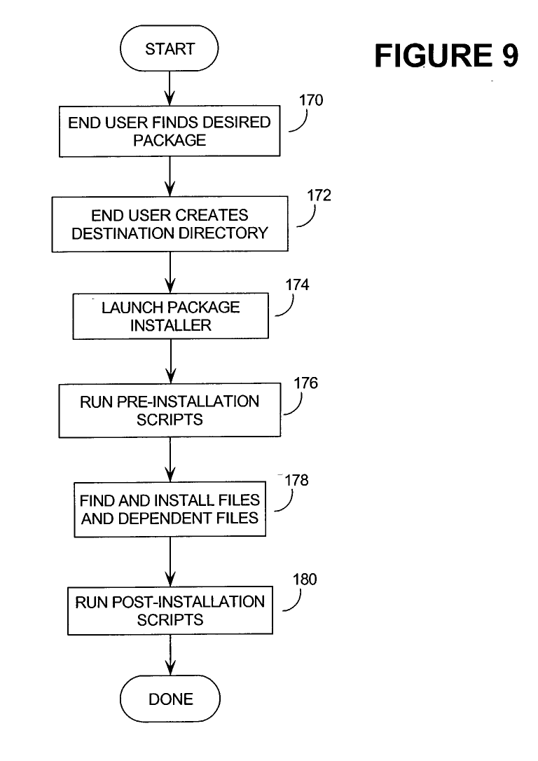

The Package Installer is a complementary software application which installs such packages on a targeted computer system, and is preferably implemented in the manner presented in FIG. 9.

The main file types used by the Packager, the Package Installer and other package building tools are as follows:

1. .qpk

The QPK file is referred to as the “Package File”, and is a compressed .tgz file containing the files to be installed;

2. .qpm

The QPM file is the “Package Manifest” file, and is an XML file describing the content of the QPK file. As will be described in greater detail hereinafter, the manifest generally includes the following information:

a. a list of files in the package;

b. where each file will be installed;

c. a description of the Package requirements the package has;

d. other packages on which it depends;

e. other packages with which it conflicts;

f. scripts to be executed on installation or uninstallation;

g. versioning information;

h. unique package identifiers; and

i. platform/processor to which the package applies, if any;

3. .qpg

The QPG file is the “Package Generation” file; an XML file that is used to provide the command-line options and answers to Packager's questions automatically, without user intervention;

4. .qpr

The QPR file is the “Package Repository” file; a compressed .tgz file containing any number of related packages and manifests; and

5. .qrm

The QRM file is a “Repository Manifest” file, which is an XML file describing the contents of a repository. A repository is simply a file storage facility which may be local or on a remote server.

When the Packager utility is executed, it will take all files under the basedir/ and put them into a package by creating a QPM file. The QPM file lists all answers to the questions, along with a list of files under the basedir/directory. Packager will also create a QNX package file (QPK) which is a tarred/gzipped archive of the manifest file (QPM), and each of the files in the basedir/directory. By default, Packager will also create a QNX repository file (QPR) which is itself a tarred/gzipped archive of the generated QPM and QPK files.

Preparing to Package

Before launching the Packager, the files that are going to be packaged must be organized into a directory structure that is compatible with the Packager, per step 30 of FIG. 2A. In the preferred embodiment, the Packager will be directed to a single directory or sub-directory, though it may have additional sub-directories of its own. Thus, the files must be organized to have a common root directory. This can be done in a number of ways, including the following:

1. Manually creating a directory structure and copying the files into the correct locations.

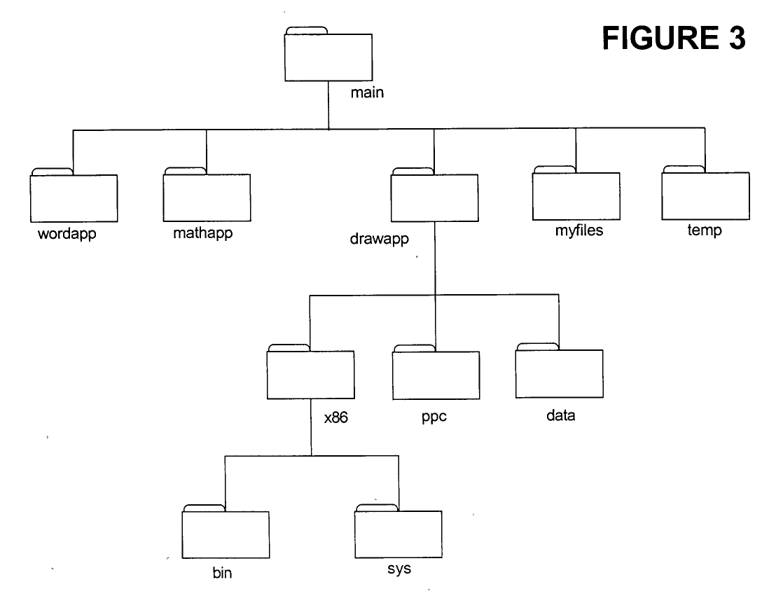

For example, one could create a file structure as shown in FIG. 3. In this example, there are four existing subdirectories under the “main” directory: /wordapp/, /mathapp/, /myfiles/ and /temp/. The end user creates a new directory called /drawapp/ to store the files for the drawing application software package he wishes to generate. The drawing application also has a number of sub-directories including a /x86/ sub-directory containing files for the x86 platform, a /ppc/ directory containing files for that platform, and a /data/ directory containing files that may be accessed on either platform. As well, the /x86/ directory is shown to have two other sub-directories, /bin/ to store binary files, and /sys/ to store system files, both being particular to the x86 platform.

Once this file structure has been generated, the end user can copy the drawing application files to the appropriate directories and the application is ready for the Packager to run.

Note that no particular file structure is necessary (such as separating the x86 and ppc files), as the Packager will automatically identify the platform each file is intended for. This is described in greater detail hereinafter.

2. Taking an existing compressed file and decompressing it into a new directory.

Again, the end user would create an empty directory to hold the files, such as “basedir” or “myappdir”, which then becomes reflective of the root filesystem (/). The compressed file or files (.tgz, .tar.gz or .tar.F files, for example) can then be copied into this directory, decompressed as required, and organized into the directory structure required by the program being packaged. Once the files are in place, the compressed file or files can be removed.

3. Taking an existing package and having the Packager unpackage it into a given directory.

As above, the end user would first create an empty directory to hold the files. Next, he would run the Packager, identifying the name of the package (either a QPK file or a QPR file) and the destination directory. For example, the file “mypackage-1.0-x86-me.qpk” could be unpackaged into the directory “basedir/”, by executing the command line code:

Packager-z mypackage-1.0-x86-me.qpk basedir/

If the end user is employing a QPR file, then all files within it will be decompressed into the basedir. If the end user is employing a QPK file, he may wish to decompress a number of the files into the same basedir. To do this, it is sufficient to enter the first part of the QPK files that are common to all desired QPK files in the current directory, as shown:

Packager-z mypackage-1.0-basedir/

Packager will extract the files from the package(s) and place them into the basedir as it would if they were installed on the root file system (/).

Note that the Packager routine should examine the directory names and file structure before generating the package, and advise the end user if awkward or unusual filenames or structures are being used. This will help the end user avoid generating a confusing or erroneous file system.

The particular restrictions on the filenames and structures will vary somewhat with the platform, and would be known to one skilled in the art.

Now that the files have been properly organized, the end user may launch the “Packager” routine at step 32, which is used to build the desired package or packages. This routine could be launched using a GUI (Graphic User Interface), command line entry, or other technique known in the art. In the preferred embodiment of the invention, the Packager is launched as a command line entry with the format:

Packager <switches><target file directory>

This command initiates the Packager routine in accordance with the values set in the switch field. In the default mode, Packager expects to be given a directory as the only argument in the <target file directory> field . This directory holds all of the files that are to be packaged, laid out in a directory structure that reflects the root (/) file system, when the files are installed.

Once launched, the Packager will first confirm that the syntax of the request and switches are sensible, and that the target directory has been properly set up. Next, it will ask the end user some basic questions at step 34 and then some package-specific questions at step 36, recording the responses in the Package Manifest (QPM) file at step 38. To describe a package the following information is generally required:

1. what files and directories will be installed on the end user's machine; and

2. where the files should appear, once installed.

To describe the software stored in the package, the following information is generally required:

1. what software this is; i.e. its name, version, release date;

2. who wrote it (i.e. the author), who is maintaining the software, and where they can be reached (i.e. their web page or email address);

3. whether the software requires other software to run;

4. whether the software is incompatible with other software;

5. whether the software forms part of a greater collection of other software; and

6. whether there are scripts or actions that must occur during installation or uninstallation.

Once all of this package information has been collected, it must be organized and stored so it can be accessed.

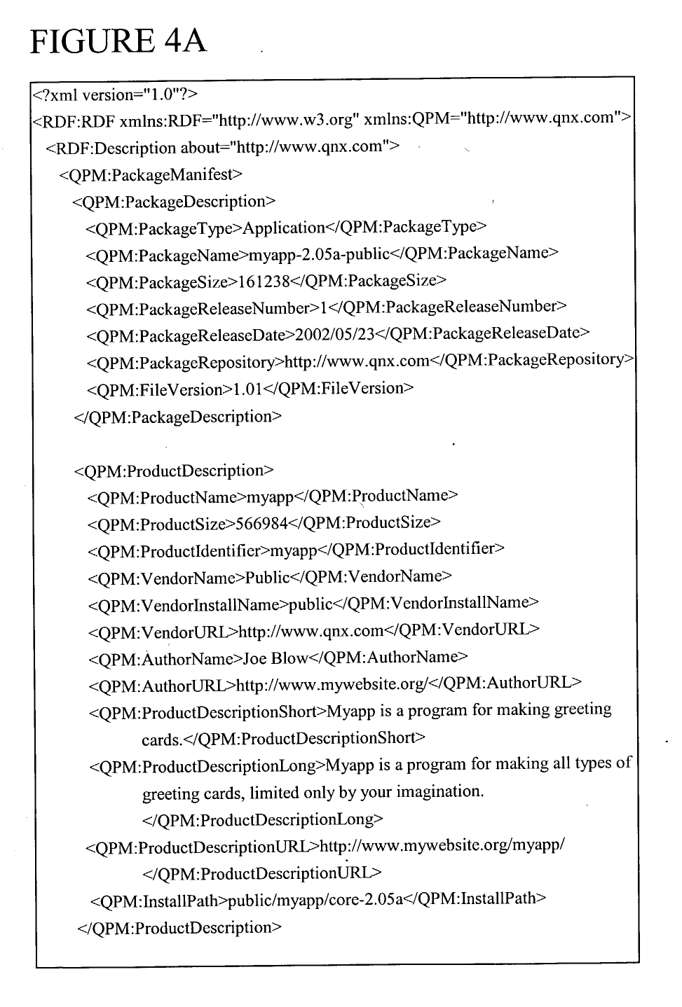

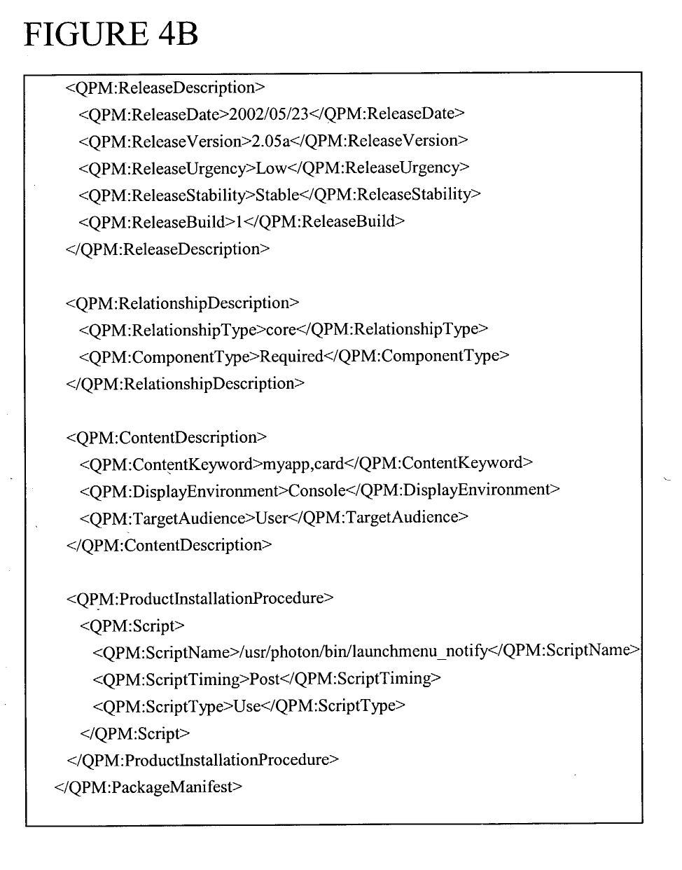

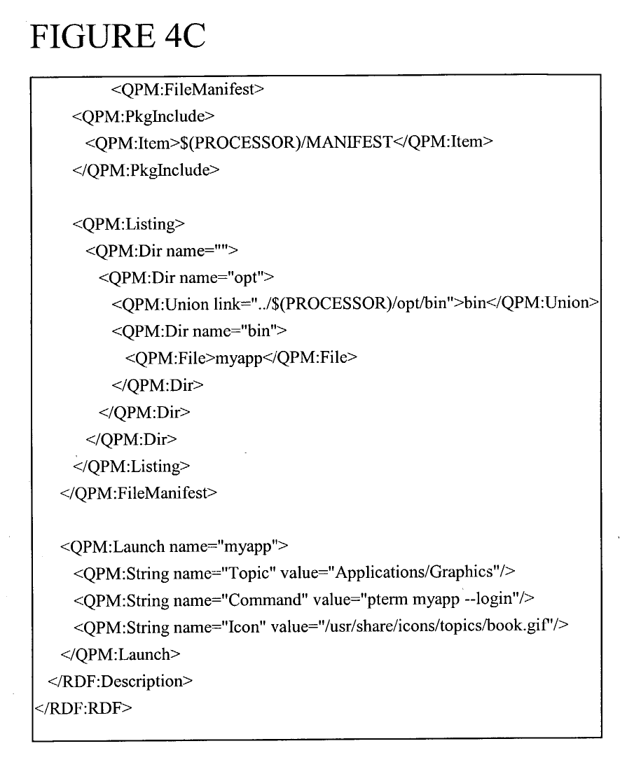

The preferred embodiment of the invention was intended to maximize the accessibility of the software packages. Hence, each software package has a separate, external data description file known as a manifest (the QPM file). The manifest is a text file which is encoded using a simple XML notation. An exemplary manifest could appear as shown in FIG. 4.

The QNX package manifest (QPM) file describes all aspects of a package, including a list of the files within the package, the locations where each of the files will be installed, a description of the package, any requirements that the package has, other packages on which the package depends (or those that conflict), and any scripts to be executed when the package is installed or uninstalled. This information (and more) is described via the QPM file.

The QPM file, which follows XML formatting guidelines, can be edited using any standard ASCII text editor. However, we recommend against editing the file by hand. Instead, any changes to the package should be done as part of a re-packaging procedure, using packager. This not only ensures that the data is entered correctly, it also updates other information automatically, such as the date that the package was created, the release number, and the size of your product. Packager also gathers and compresses your files into the required structure, according to the desired parameters.

The QPM file can be edited using any standard ASCII text editor, however, end users should be cautioned against editing the file by hand. Instead, any changes to the package should be done as part of a re-packaging procedure, using Packager (this is described in greater detail hereinafter). This not only ensures that the data is entered correctly, it also updates other information automatically, such as the date that the package was created, the release number, and the size of the product.

As noted above, the Packager asks many questions at steps 34 and 36, so that a useful and effective package is created. Thus, the end user should not be able to avoid the questions that the Packager asks. Optionally though, the end user could be able to reuse answers from a previous manifest by setting an appropriate switch in the command line.

The Packager utility is preferably pre-programmed with certain default values to assist the end user in generating packages. When the end user is asked a question, the Packager will appear with a set of parentheses surrounding the default value: (default).

The Packager should also provide the end user with detailed comments and instructions about each question (by default). There should also be a facility to disable this mode once the end user is accustomed to the use of the Packager utility, reducing the amount of documentation shown on screen for each question.

In the preferred embodiment, Packager will not let the end user simply enter default answers for every question. Some questions absolutely require a response, especially those that determine the uniqueness of the package (i.e. product identifier and vendor identifier) and those which ensure that it does not conflict with other packages. If these values are not entered, Packager will sound the system bell.

It is also preferable that warnings be sounded to caution the end user while packages are being created. For example, the end user should be warned if they attempt to union incompatible file directories, or use a directory name that is generally reserved for a different purpose.

Basic Questions

The invention could be implemented in many different ways, requiring a wide vary of information to be incorporated into the manifests. The following data would commonly be required for most applications though, so the end user would be queried for this information at step 34:

1. product identifier

This is the name used by other packages to reference the package being generated. It should be a short, simple identifier (no more than 13 characters), and be made up only of alphanumeric characters, dashes, or underscores.

2. vendor identifier

Identifies the company or software developer so that the packages do not conflict with other packages that have identical product identifiers. Together, the vendor identifier and product identifier should describe the product uniquely within the program environment.

3. release version

Indicates the version number of the product, e.g. 1.0, 2.3.4, 14.2A, and so on.

If software is being ported from another source, the software's original version number should be used and the release build number changed each time the software is re-packaged. By doing this, the version number accurately reflects the source program's version.

4. release build

An integer that indicates the build number of the package. This number should be incremented by one each time the software is changed, unless the version number changes. The release build number should be reset to “1” whenever the version number changes.

5. package release number

An integer indicating the release number of the package. This number should be incremented by one each time the software is re-packaged, even if the software has not changed. This number should be reset to “1” whenever the version or build number changes.

6. content topic

In the preferred embodiment, the Packager utility is pre-programmed with a list of available topics, though more topics can be added by the end user.

The Packager allows the end user to select more and more specific topics until the location of the package in the repository has been fully described. Packager allows users to search by keyword to quickly find an appropriate topic. The more specific the developer is in choosing the topic, the more organized the repository will be later, especially if the repository includes many packages.

7. product name

The product's name is obviously very important in telling the end user exactly what they are about to download/install. This is the name that will appear in the Package Installer in the list of packages in the repository, and should be a descriptive, capitalized name such as: “Packager” or “Package Installer”. The Package Installer will automatically attach “for x86,” or similar qualifiers on the end when the package is displayed, so the end user does not have to enter the processor or version references in this field.

8. product description long

This field defines the complete textual description that will appear in the Package Installer when an end user clicks on the software package (in the list of available packages). A good description can help end users find the software package more easily, as this field is searched by the Package Installer when the find function is used.

9. license URL

To have a license show up when the software package is installed, the end user can specify the URL of the license file as the response to this question. Alternatively, if the license resides in a file on the local hard drive, a copy of the license file can be included in the package (QPR) simply by identifying the file path and name in response to this question, rather than putting the license file into the basedir directory structure. The Packager will then copy the file into the package.repdata directory which corresponds to the package and will display a message stating that the file has been copied into the package.

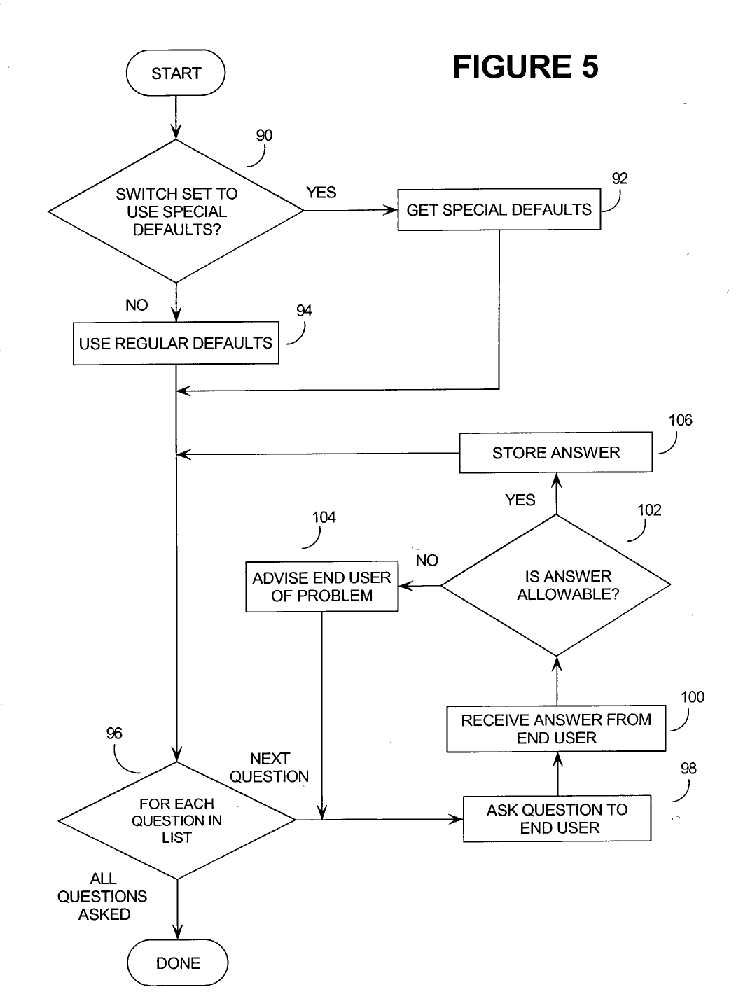

This process of querying the end user is described in greater detail with respect to FIG. 5. FIG. 5 presents a flow chart of the method of querying the end user. The routine begins at step 90 where the end user is asked whether he wished to use a special set of responses as the default. As noted above, the preferred embodiment of the invention is to use a command-line entry to launch the Packager. Thus, a switch can be set in this command-line which calls the QPM file of another package to be used as the default responses. Referring to FIG. 5, the call to use a special set of responses as the default, is made at step 92, otherwise, the standard defaults are called at step 94.

The routine now cycles through the list of questions at step 96. For each question, the question is presented to the end user at step 98 and a response received at step 100. As noted above, it is preferred than an answer be required for each questions, but this could be over-ridden.

The received answer is then divided for suitability at step 102. If it is not allowable, the end user is advised of the problem at step 104, and the question is passed again at step 98. If the answer is deceived allowable at step 102, then the answer is stored at step 106.

The process is then repeated until it is determined at step 96, that there are no further questions.

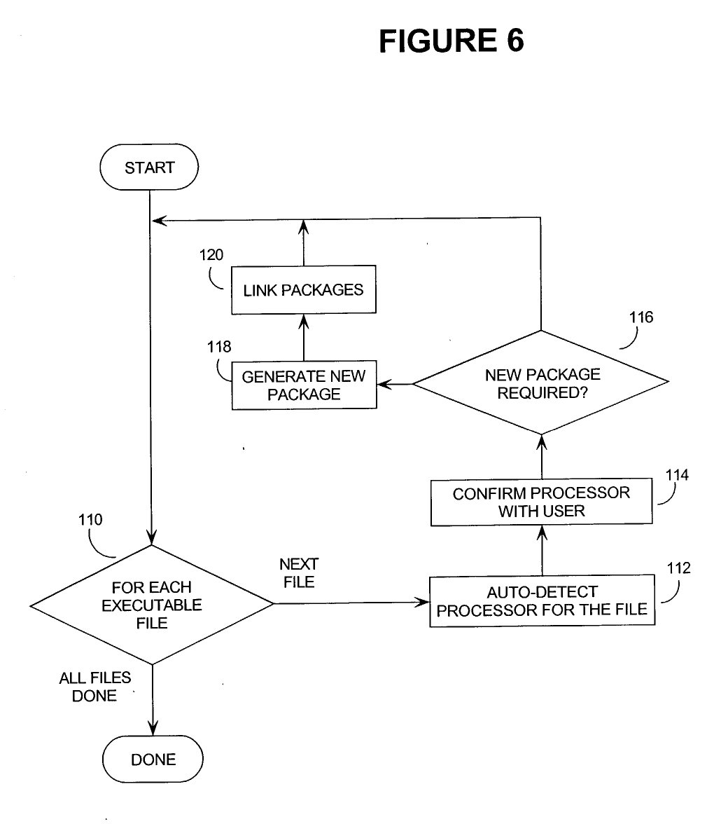

After the Packager has asked the basic questions, it will sort the software into the packages needed to properly install the product at step 33. Once this sorting is complete, a second set of questions will be asked. This sorting process is described in greater detail with respect to FIG. 6.

Package-specific Questions

As noted above, the Packager automatically sorts files into separate packages in accordance with predetermined criteria. In the preferred embodiment, the sorting criteria is the platform that the files are to execute on. In addition to the automatic sorting, the end user can optionally override the determinations that the Packager makes.

As shown in FIG. 6, the Packager considers each file in the targeted directory, identifying the executable files at step 110. An auto-detection is then performed on each executable file at step 112 to determine which platform the file will operate on. As noted above, this auto-detection is typically done by examining the extension on the filename, or examining the ELF header. This determination is then optionally confirmed with the end user at step 114, giving him the opportunity to verify the determination made by the Packager and make changes as desired.

The Packager then decides whether a new package is required at step 116. That is, if a package has already been created for the platform that the current file is intend for, the current file is simply directed to that package. If a package has not yet been opened for that platform, it is opened at step 118. The new package (which will be a processor-specific package), is then linked to the parent package (generally a processor-independent package) at step 120.

Thus, if there are files for two platforms, the end user will see three QPM files and three QPK files generated, and the QPR file will be an archive of all six files. In fact, if there are files to be hosted on other processors, a separate QPK and QPM file will be created for each processor as well as the common processor independent QPK and QPM files.

If there are executable files that generate files targeting different processors or header (.h) files, Packager will start to create development packages with a -dev-qualifier in the file name. There is no limit to how many packages Packager may create as it works, although one may expect to see two for a standard package, and perhaps six for an advanced package.

Each processor-specific package has a reference in its QPM which indicates that it is a COMPONENT package, and has a reference back to its CORE package. Later, when the package is being installed, the Installer will recognize that it is not a CORE package, and ensure that the CORE package is also installed when the COMPONENT package is installed.

The Package Installer will also automatically turn any required shared objects into dependencies that must be satisfied in order for the package to be installed. This is done by checking the ELF integration of executable files and looking for NEEDED flags, which indicate other libraries which must be installed (for the same processor as the file itself) in order that the executable can run. This would be done in a similar way for other executable formats. Thus, when the QPM files are being generated by the Packager, these NEEDED tags must be inserted, indicating the name of the required library.

Once these separate packages have been generated, processing continues per step 36 of FIG. 2A, where questions are asked that are specific to each separate package.

Different questions apply to different packages. So for each package, Packager will first display the name of the package, and then ask the questions. These questions are divided into three main sections:

1. scripts;

2. dependencies; and

3. the QNX Photon® launch menu.

Scripts

Once an end user has installed a software package, it may be desirable to display a splash screen or a readme file, or execute some other script to finish the installation. It may also be desirable to run a script during uninstallation, for example, confirming that a particular uninstallation has been performed successfully.

Scripts can be executed at eight different times during the life of a package:

1. Pre-install or Post-install (i.e. before or after the installation takes place);

2. Pre-use or Post-use (i.e. before or after the activation of a package);

3. Pre-unuse or Post-unuse (i.e. before or after the deactivation of a package); or

4. Pre-uninstall or Post-uninstall (i.e. before or after the removal of a package).

As well as choosing when the script will execute, the end user may decide to execute either his own script, or to simply run a program that is available on the file system.

Most operating systems already have the functionality to detect when a package has been installed, activated, deactivated, or uninstalled. It is therefore straightforward to add a script which is responsive to such a detection, to a package.

Dependencies

The software package being generated may be dependent upon another package having been installed in order to operate correctly. Such requirements are specified by entering dependencies.

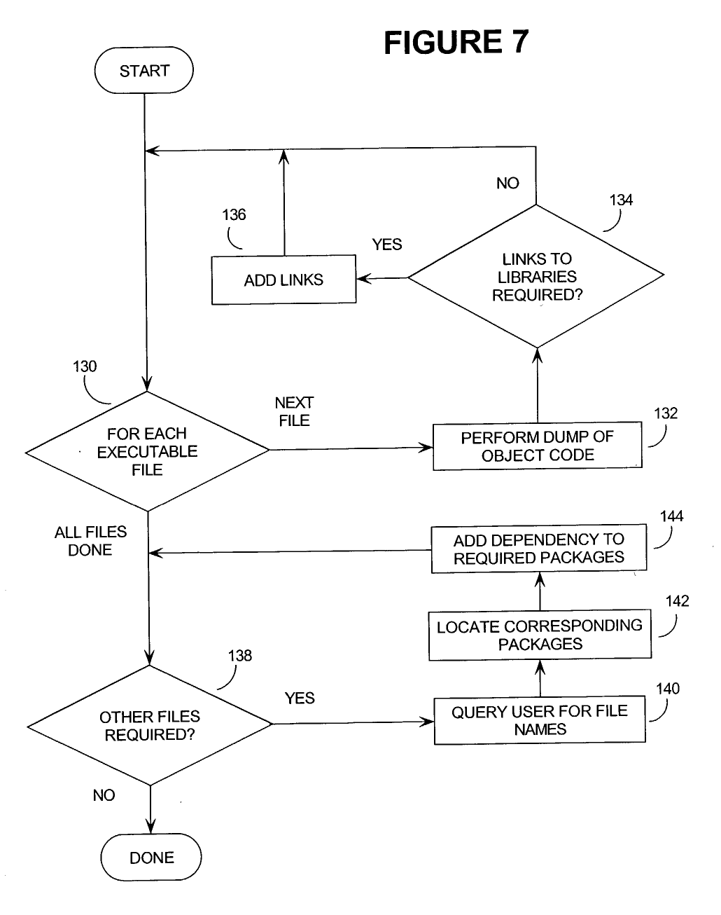

The Packager will automatically insert tags into the software package that detail any shared object libraries which are either contained in the package, or are required by the package. Thus, it is not necessary for the end user to enter these dependencies. This process is presented in detail in the flow chart of FIG. 7.

This routine cycles through each of the executable files in the package at step 130, and one at a time, performs a dump of the object code at step 132. From this object code, the routine determines whether any links to libraries exist, at step 134. If so, the links are added at step 136, otherwise, the routine simply loops back to step 130, where the next executable file in the package is considered.

Once all of the executable files have been considered, the routine queries the end user at step 138, to identify any other files that are necessary for the normal operation of the software package. If there are none, the routine is complete; otherwise, control passes to step 140, where the end user is asked to provide the file names and paths of the dependent files. The packages associated with these files are then located by the Packager at step 142, simply by checking the local manifests. When the package is found, it is identified as a dependent package in the QPM at step 144. If it is not found, then a new package can be created to support it.

In the preferred embodiment, the Package Installer automatically turns any required shared objects into dependencies that must be satisfied in order for the package to be installed. Thus, it is not necessary to add dependencies on packages that provide shared objects that the product inherently requires.

Also, the Packager automatically puts in dependencies between any development packages that it generates, so the end user need not add dependencies between these packages either.

The Packager does this by automatically detecting any shared object libraries that are being packaged (.so files) and inserting a corresponding <QPM:ContainsLibrary> tag into the manifest of a package that contains such a library. For example, if it is determined that the library libmine.so.1 is being packaged, then the Packager will insert the following line into the manifest:

<QPM:ContainsLibrary>libmine.so.1</QPM:ContainsLibrary>

Similarly, if any files being packaged require a shared object library in order to operate correctly and such a library is not being packaged alongside this file, then Packager will automatically add a corresponding <QPM:RequiresLibrary> tag into the manifest of the package that contains such a requirement. This becomes an automatic dependency when the package is installed. If the required library is not available, the Package Installer will search all installed software to try to find another package that contains the required library. If such a package is not installed, the Package Installer will search all known repositories for a package that contains the corresponding <QPM:ProvidesLibrary> tag. To avoid downloading a large package that happens to contain the library that is required, and perhaps a lot of unnecessary files as well, the Package Installer tries to find a small package that contains only a set of libraries. Such a package is called a SLIB (shared library) package.

When a shared object library is detected, it is placed into the package being generated and the library is placed into a SLIB package. This SLIB package has a similar name to the package being made; the only difference is that the component name has “slib-” added to it. The SLIB package will be made available alongside the product (in the same repository), but it will not show up in the Package Installer as a new package. It is only there for dependency resolution, in case someone who does not already have the product installed, is installing a package that requires a special library.

For example, if the end user is packaging a QNX Photon microGUI application, the application will already have requirements on phlib.so.1 internally (the Photon library), and Packager puts these requirement into the package. The great advantage of SLIB packages is that it is not necessary to have a separate dependency that QNX Photon be installed, since this will happen automatically when the package is installed.

QNX Photon Launch GUI (Graphic User Interface)

A GUI is a simply a graphic interface between the end user and the computer, where data is displayed using text and/or graphics and interaction is generally sophisticated (i.e. commands are typically effected in such an environment using a mouse and pull-down menus or toolbars). The QNX Photon GUI is a particular GUI which is designed to run with the QNX operating system. Of course, the launch GUI could also be implemented in other operating system environments.

The end user may also specify any number of launch menu items to appear in QNX Photon GUI when this package is active. For each launch menu, the end user answers the questions as follows:

1. launch menu label

The name that will appear on the launch menu (should not exceed 25 characters);

2. launch menu position

The hierarchy under which the entry will appear. Any values can be entered here, but they must all be under the Applications/heading. The end user should be encouraged to stick to the standard ones shown in the launch menu (i.e. Applications/Editors, Applications/Utilities, Applications/Internet, Applications/MultiMedia, Applications/Development or Applications/Games); and

3. execution command

The command that will be executed when the operator clicks on the menu item. This must be a fully qualified command (i.e. /usr/photon/bin/ped-r readme.txt).

When the Packager has the responses it needs for each package, it can generate the manifest (QPM) for each file at step 38 of FIG. 2A.

The Package file system then begins to generate the QPK file at step 40 by compressing the QPM file for each package, and adding the QPM to the QPK files to it. The Packager continues by compressing each of the files in the targeted directory (which were sorted into separate packages at step 35), and adding it to its particular QPK file, at step 42.

Any individual library files, identified at step 132 above, are also copied to the QPK file at this time, at step 44. Any additional links are also made at this time, at step 46.

Working with a Package-generation File

With the QPM and QPK files now complete, the generation of the software packages themselves is now finished, so these files could now be handled as desired. However, the method of the invention offers additional functionality via steps 48 through 58 of FIG. 2B, for example, that are very useful.

Steps 48 through 52, for example, allow the end user to generate a QPG (QNX Package Generation) file, which automates the packaging process to a great degree. This means that future changes to the software package are easily reflected in a new package without having to re-enter responses to the queries or re-construct the original file system.

The QPG file is used to provide the command-line options and answers to Packager's questions automatically, without user intervention. Like the QPM file, it is also an XML-style document that can be edited using any standard ASCII text editor.

In the preferred embodiment, a preliminary QPG file may be generated by means of a command line entry, such as: Packager-m mypackage.qpr-x basedir. This command generates a file called “xpackage.qpg” which contains the manifest values within the package, and a reference to each of the files inside the package. The “basedir” specified should be the directory in which the files reside that was created in the initial packaging session.

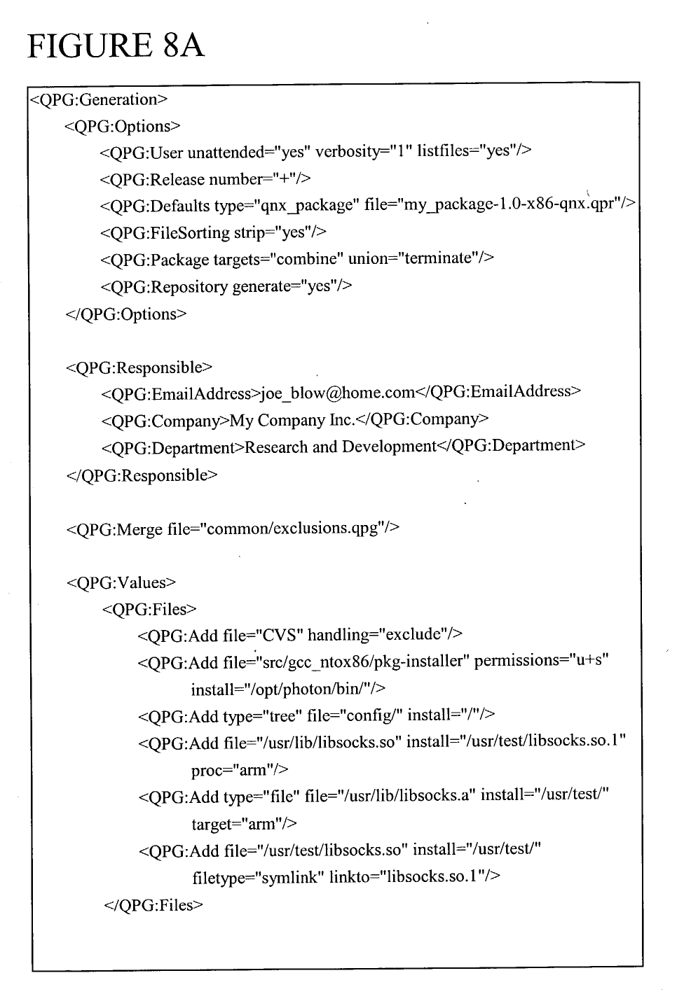

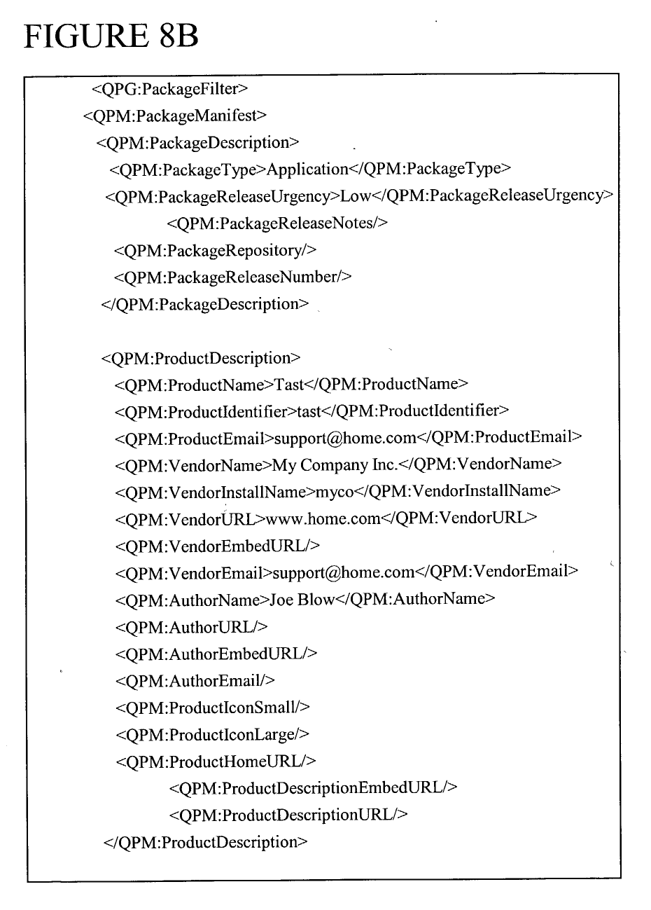

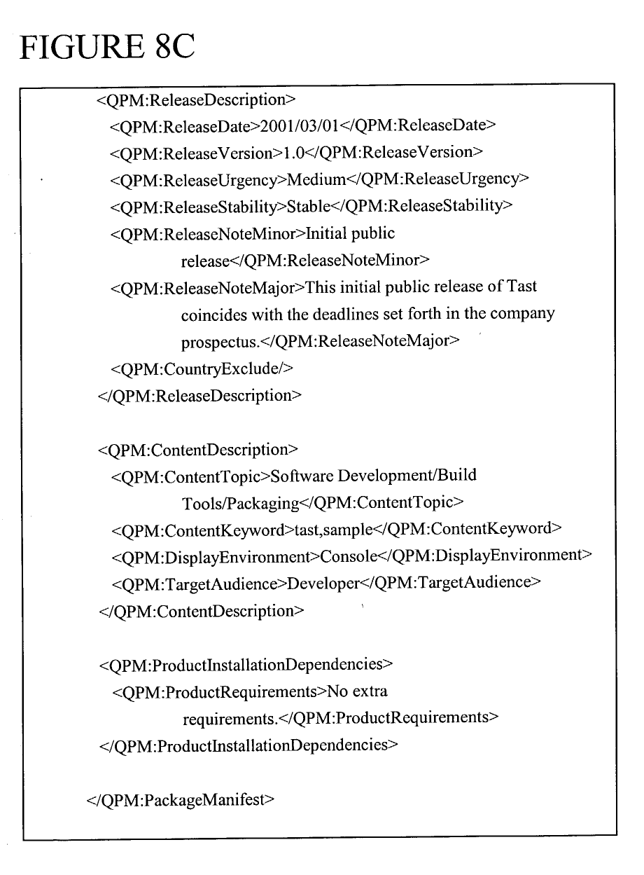

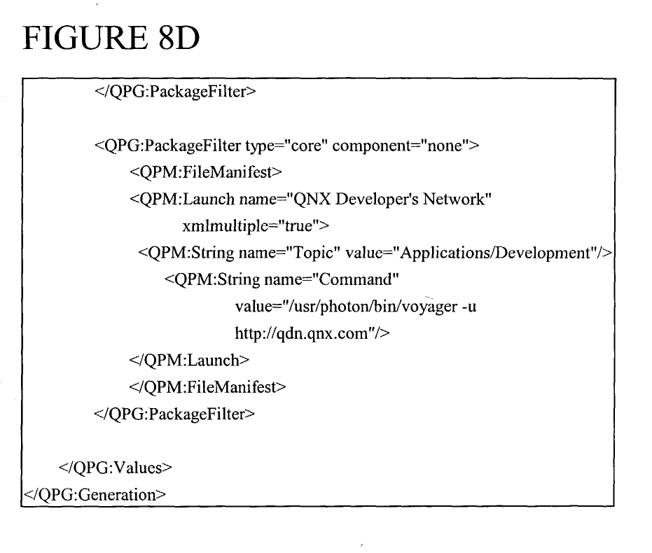

The main sections of the QPG file are described with respect to the example presented in FIGS. 8A through 8D. These sections include:

1. command-line options per item 150 of FIG. 8A;

2. ownership/editor specifications of the package per item 152 of FIG. 8A;

3. a listing of other QPG files to merge as if they are part of the same QPG, item 154 of FIG. 8A;

4. a list of manifest values that the Packager uses as answers to its questions, per item 158 of FIG. 8B and item 158 of FIG. 8C; and

5. a list of files to be packaged, along with their installation locations per item 156 of FIG. 8A.

A list of manifest values which are specific to one or more (but not all) packages, as defined by a package filter is shown as item 159 on FIG. 8D.

Generation of the QPG file in response to an end user request at step 48, is therefore quite straightforward. All of the package-specific data is available from the corresponding QPM. Generation of the QPG therefore comprises obtaining this information, manipulating it in accordance with the command line options, and adding the additional lines of code that allow it to communicate with the Package utilities.

Of course, if the end user does not wish to generate a QPG file, then control passes directly to step 54.

There are many options available for the QPG file, several of which are described hereinafter. There are, of course, many additional options.

Editing the QPG File

Once the QPG has been generated, it is easily edited at step 50 using an ASCII editor or some similar package.

The list of files 156 <QPG:Files> is the most advanced (and flexible) part of the QPG file. Here, one can list the files that are to be packaged from a hard disk (in any location), the location where they should appear once the package is installed, the types of files they are, any special handling for the files, and any files that should be excluded from the package.

Packager will automatically determine each of these values, if they are not specified, as long as the source file name (file=“”) and the install location (install=“”) are provided.

The <QPG:PackageFilter> section is where the tags of manifests that are to appear in the final package manifest(s), must be placed. The easiest way to fill in this section is to let Packager create the QPG file using the “-x” option. However, to add a special feature of some kind, such as launch menu items, this section can be edited to include all the tags that are required. Some manifest tags are Packager-determined each time Packager is run, so specifying those values will have no effect in the generated packages. An empty tag has the effect of suppressing the question for that tag, when running Packager in attended mode.

Symbolic Links

To create a symbolic link, another <QPG:Add> line is simply added to the QPG file. But this time, the entries must be changed to look like this:

<QPG:Add file=“sym_link_name” install=“/opt/bin/” filetype=“symlink”

linkto=“file/to/link/to“/>

When Packager detects the filetype=“symlink” attribute, it recognizes this as a request to put a symbolic link into a package. The Packager will automatically search the other files being packaged, looking for the file to which the symbolic link points. When such a file is found, the symbolic link is placed into the same package as that file.

For example, to add a file from a hard drive (libmine.so), but install it as a different file (libmine.so.1), and then create a symbolic link (libmine.so->libmine.so.1), one must enter the following code:

<QPG:Add file=“src/lib/libmine.so” install=“/opt/lib/libmine.so.1”/>
<QPG:Add file=“libmine.so” install=“/opt/lib/” filetype=“symlink”

linkto=libmine.so.1”/>

Working With Components

Components are simply optional parts of a master product. Parts of your software can be installed with or without other components. For example, think of the set of QNX Photon® microGUI packages, which consists of a core package, a drivers component, a games component, and other components. With a single session of Packager, one can generate a product and all of its components.

Any file that is being packaged can be specified to be part of a component. To specify which component a given file is to be part of, simply add a component=“”)

to the <QPG:Add> line:
<QPG:Add file=“bin/my_game” install=“opt/bin/” component=“games”/>

When Packager finds such a line, the file will be put into a new package that has a <QPM:PackageModel> of “games,” with the same product identifier as the core package.

This new package is independent of the other portions of the product, but its installation location will be alongside the rest of the product it is derived from. For example:

/pkgs/base/qnx/ph/core-2.0.2/

/pkgs/base/qnx/ph/games-2.0.2/

/pkgs/base/qnx/ph/drivers-2.0.2/

Note that Packager uses components automatically when it detects that development files are being packaged. For example, if some header (*.h) files are being packaged, Packager will detect these files being packaged and will automatically create a component for the package called “dev.” This development package will contain all of the files that are part of the software development process. Only executable files and configuration files actually go into the core product itself.

Forcing Files Into Certain Packages

If the end user did not intend to include development files when packaging the software, or if Packager puts a file into a package that had not been intended, it is possible to force files to be handled differently. To do this, specifications can be added to the <QPG:Add> line to tell Packager exactly how to handle the file.

Below are some examples below showing common ways to redirect files:

1. Packager uses the ELF header information, along with the file name extension, to determine what type of file is being packaged. After this determination, the file will automatically be assigned a “file type.” This default can be overridden, forcing a change to the file type, by setting the filetype=“” attribute. For instance, set filetype=“exe” to force a file to be considered executable, and to appear in a processor-specific package that corresponds to a proc=“processor” attribute, like this:

<QPG:Add file=“src/include/readme.txt” filetype=“exe” proc=“x86”

install=“/opt/share/”/>

2. Merging other QPG files

Merging additional QPG files is easy. By adding a <QPG:Merge> entry into your QPG file, you can simplify a complicated product into a number of easy-to-manage QPG files. Note that the <QPG:Options> block is only read from the primary QPG file; a merged QPG file's option block will be ignored by Packager.

For example, your package.qpg file might show:

<QPG:Merge file=“author.qpg”/>

<QPG:Merge file=“drivers.qpg”/>

<QPG:Merge file=“/home/common/license.qpg”/>

These three lines of code would merge the three packages with the current package; that is, the author.qpg file ( ), the drivers.qpg file and the /home/common/license.qpg/file (which contains the license agreement). When merging, it may be desirable to apply a set of file attributes to an entire QPG file. For instance, one might change the destination component for the files referenced within the QPG. To do this, use a <QPG:MergeFilter> block with the desired attributes around any number of <QPG:Merge> commands:

<QPG:MergeFilter component=“games”>

<QPG:Merge file=“src/games/photon_games.qpg”/>
<QPG:Merge file=“src/games/xphoton_games.qpg”/>

</QPG:MergeFilter>

Regenerating a Package

Once the editing of the QPG file has been completed, new QPM and QPK files must be generated. These files would be generated basically in the manner presented above with respect to steps 34 through 46 of FIG. 2A, except that the software already has responses to all of the queries. Thus, it can proceed through these steps in an automated way.

Each time a package is generated, at least one of its version number, its build number, or its release number should be changed. By doing so, it is ensured that the Package Installer will uninstall any previous versions of the program and will recognize the package as being a newer version than the one already installed.

Version numbers for the software can change at any time, usually indicating that a set of features have changed, or that a new architecture is in place.

If the same version is being kept, the build number (an integer) can be changed to indicate that the software has been rebuilt, perhaps after fixing bugs or making minor changes.

If the same version and build number is being kept, the release number can be changed to indicate that the software has not been modified and is simply being repackaged. The release number, an integer, will be automatically incremented by Packager each time it is executed, although it will be reset to “1” whenever the build number changes. The version, build and release numbers are all maintained using their corresponding tags, respectively, the <QPM:ReleaseVersion>, <QPM:ReleaseBuild> and <QPM:PackageReleaseNumber> tags.

Placing Packages in a Repository

Prior to placing a package in a repository, it would be desirable to test the package per step 54. This would be done by simply running the Packager Installer program and verifying that the package is unpackaged as expected, and operates correctly. If the testing is successful, then the QPM and QPK files of the package can be stored in a repository so they can be distributed.

Having a repository is great for sharing a lot of files that he end user wants people to browse through. If the invention is being applied to a company or fan web site though, the end user may want people to install a package by simply clicking on a hyperlink. The invention supports this with something called the package repository file (QPR file) which can be generated at step 56. This file is just an entire repository file tar'd and gzip'd with a new unique extension.

For instance, if someone using the QNX realtime platform clicks on a hyperlink ending in the extension .qpr, the web browser will launch the Package Installer with a command-line option to immediately install the files.

By creating a robust, well-documented description set for packages, one can organize huge amounts of software easily. For example, since a package is associated with a software topic, tools like the QNX Package Installer can visually categorize the software for easy access. Several hundred predefined categories have been provided, each with its own icon and description.

Users will see these categories as soon as your package is placed into a repository.

The manner in which packages are placed in a repository will vary with the specific application. In the preferred embodiment, one would place all of the desired QPM and QPK files into the repository directory. (If you are working with QPR files, decompress them using tar −zxf my_package.qpr).

The description will be the first thing an end user sees when they click on a repository, so it should be as detailed and accurate as possible.

In generating a repository, Packager will create the following files:

1. index—a list of the files in the repository;

2. content.tgz—an archive of all of the QPM files in the repository, which have been stripped of the file listing section (for faster download), including all support files like licenses, scripts, and web pages; and

3. repository.qrm—a repository manifest file with details about the number of packages in the repository, a web site, icons, and a description of the repository, and a listing of all packages in that repository.

Where the package information should be stored depends on how people would want to use it. The preferred embodiment of the invention works from the premise that most software is now shared, traded, or downloaded from web sites and FTP sites. Consequently, the tools to manipulate software packages would be limited by bandwidth. Thus, each software package is intended to have a separate, external data description file known as a manifest.

If you place a collection of packages and their external manifests on an FTP site, you have what we consider an archive repository, a place where a package administration tool can find and install software.

From the Package Installer's perspective, any directory, web site, or FTP site that has a package and the package's manifest is a legal archive repository. Unfortunately, due to the security restrictions of some servers, the Package Installer may be unable to read the contents of a web site or an FTP site. So, before it does anything else, the Package Installer looks for a repository description file, repository.qrm, which is also known as the repository manifest.

The Package Installer

The Package Installer program functions much like installer programs known in the art except that it performs certain operations which are complementary to those of the Packager described above.

As noted above, the field in the QPM manifest called: “product description long” is the field searched by the Package Installer when the find function is used. This is the operation that the end user employs at step 170, to find the packages he desires.

As note above, some FTP sites and web sites will not allow the Package Installer to directly check which packages are in the repository. So, to make maintenance easier, a simple text file is used, containing the public contents of the repository; this file is defined by the PackageList tag. To generate this index file, simply type Is>index.

All the other description and content tags in the repository.qrm file are optional. To maintain the repository, all the end user should have to do is FTP the packages and recreate the index file.

As noted above, the rep:// prefix inside the QPM file tells the Package Installer to use the repository directory as the relative base position for the rest of this URL. One of the original design goals was to promote mirroring and to simplify the distribution of packages and repositories. To avoid the requirement for hard-coded URLs, repository reference URLs were employed. For example, the prefix rep://foo would tell the Installer to look for a directly called foo in the base of the repository. In the above sample, SummaryURL is located at http://207.198.90.123/repository/index.html.

Once the desired package is found, the end user would launch the Package Installer at step 174, identifying the name of the package (either a QPK file or a QPR file). For example, the file “mypackage-1.0-x86-me.qpr” could be unpackaged into the directory “basedir/”, by executing the command line code:

PackageInstaller -u mypackage-1.0-x86-me.qpr

The user is then presented with the list of packages which are available within the repository to be installed. Once the desired packages are chosen for the installation, the pre-installation scripts which are included as part of this package, would be executed at step 176.

Next, the package itself will be uncompressed (if necessary) and the files in the package loaded to the target directory at step 178.

Each selected processor-specific package has a reference in its QPM which indicates that it is a COMPONENT package, and has a reference back to its CORE package. The installer recognizes that it is not a CORE package, and ensures that the CORE package is also installed when this package is installed.

The Package Installer then automatically turns any required shared objects into dependencies that must be satisfied in order for your package to be installed. When checking the ELF header of executable files, Packager looks for NEEDED flags, which indicate other libraries which must be installed (for the same processor as the file itself) in order that the executable can run. When these NEEDED tags are found, a line is added to the QPM which indicates the name of the required library. When the Installer detects such tags, it checks the currently installed software, and other packages, to ensure that another package which contains the required library is also installed/available, or the original package will not install.

Finally, any post-installation scripts are now executed at step 180, and the installation is complete.

Options

Clearly, the invention could be implemented with many options that have not been mentioned herein. Many options are already known in the art, and many new options would be clear from the teachings herein, including the following:

1. Packager automatically strips the executable files so that unnecessary debug information is not left in the packaged files. This behaviour is sometimes undesirable, so it can be turned it off. To change this for the entire session, the following setting can be made in the <QPG:Options> section:

<QPG:FileSorting strip=“no”/>

This option turns off all strip operations. As an alternative, one can define that a particular file not be stripped when packaged, as shown here:

<QPG:Add file=“src/bin/my_program” install=“/opt/bin/” strip=“no”/>

2. Packager attempts to keep the file's ownership, group, and permissions identical to the original file's settings. To override this behaviour, or to apply specific settings to a file, use the permissions=“”, user=“”, and/or group=″″ attributes, as required:

<QPG:Add file=“src/bin/my_program” install=“/opt/bin/”

permissions=“x+s”/>

While particular embodiments of the present invention have been shown and described, it is clear that changes and modifications may be made to such embodiments without departing from the true scope and spirit of the invention. For example, the invention has been described with respect to a personal computer/remote server environment, but could equally apply to television set top boxes, personal digital assistants (PDAs), Internet-ready cellular telephones and the like. In fact, the efficiencies of the invention are even more important in such environments than in the PC environment.

Although the cost of electronic memory has dropped dramatically in price recently, it is still expensive for certain applications such as television set top boxes where a large quantity of memory is required and the market will only accept very low cost devices. A large quantity of memory also corresponds with a great deal of physical space and large power consumption, neither of which the market desire either. Physical limitations are also a great concern in other embedded systems such as in PDAs and in automobiles. Where memory capacity is at a premium as in such devices, there is an incentive to minimize the amount of memory capacity required.

As well, the bandwidth of wireless communication is still very restricted, so even a small reduction in the data volume to be transmitted would be very desirable.

The method steps of the invention may be embodiment in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-Roms, Random Access Memory (RAM) and Read Only Memory (ROM) may be programmed to execute such method steps. As well, electronic signals representing these method steps may also be transmitted via a communication network.

It would also be clear to one skilled in the art that this invention need not be limited to the existing scope of computers and computer systems as described. These terms have been used herein to simplify the discussion and do not strictly limit the invention to the former definitions of such hardware.

What is claimed is:

1. A method of preparing files for downloading and installation, comprising the steps of:
identifying the files desired to be downloaded and installed;
sorting said identified files into parameter-specific and parameter-independent groups; and
generating a separate package each of said separate groups of said identified files,
whereby separate parameter-specific and parameter-independent packages are generated.

2. The method of claim 1, wherein said parameter comprises a specific platform.

3. The method of claim 1, wherein said parameter comprises a specific processor.

4. The method of claim 3, wherein said processor-independent package comprises a core package.

5. The method of claim 3, further comprising the steps of:
automatically detecting files made to execute on a particular processor; and
linking processor-specific and processor-independent files automatically.

6. The method of claim 1, wherein said parameter comprises a specific software application.

7. The method of claim 6, wherein said parameter comprises a specific version of a software application.

8. The method of claim 1, further comprising the step of:
identifying the parameter with respect to which said files are to be sorted into groups.

9. The method of claim 8, wherein said package includes a package manifest file (QPM file).

10. The method of claim 1, wherein said package includes a compressed package manifest and file (QPK file).

11. The method of claim 9, wherein said package includes a package repository (QPR file), said QPR file being a compressed QPM and QPK file.

12. The method of claim 2, further comprising the steps of:
automatically detecting files made to execute on a particular platform; and
linking platform-specific and platform-independent files automatically.

13. The method of claim 1, further comprising the step of:
responding to a manual request for dependency, by automatically determining the package from which the file originates and adding the dependency on that package, to the new package.

14. The method of claim 1, further comprising the steps of:
automatically identifying dependencies between packages; and
responding to the existence of a dependency by adding dependencies between packages.

15. The method of claim 8, further comprising the step of:
querying the end user to identify the parameter on which said step of sorting is based.

16. The method of claim 15, wherein said queries are either general or package specific.

17. The method of claim 15, comprising the step of allowing said end user to use responses to previous queries as a default template.

18. The method of claim 15, comprising the step of providing default responses to some questions as an option for said end user.

19. The method of claim 15, wherein said step of sorting comprises the steps of:
reading the file extension for each of said identified files; and
sorting said identified files by file extension.

20. The method of claim 15, wherein said step of sorting comprises the steps of:
reading the file header for each of said identified files; and
sorting said identified files by file header.

21. The method of claim 15, wherein said step of querying comprising the steps of:
issuing mandatory queries to said end user for certain parameters of the package; and
responding to the failure of said end user to provide responses to said mandatory queries, by abandoning the attempt to generate a package.

22. The method of claim 1, wherein said step of sorting comprises the step of sorting said identified files manually.

23. A method of preparing files for downloading and installation, comprising the steps of:
identifying the files desired to be downloaded and installed;
sorting said identified files into two or more groups, at least one of said groups of files containing files which are common to more than one application, and at least one of said groups of files containing files which are not common to more than one application; and
generating separate packages for said first and second groups of files.

24. A system for distributing software, comprising:
a personal computer;
a server; and
a communication network for interconnecting said personal computer;
a server;
wherein said server is operable to:
identify files to be downloaded and installed on said personal computer;
sort said identified files into separate groups by parameter-specific and parameter-independent groups; and
generate a separate package each of said separate groups of said identified files;
whereby said personal computer may download said identified files by downloading separate parameter-specific and parameter-independent packages.

25. An apparatus operable to perform the methods steps of:
identifying the files desired to be downloaded and installed;
sorting said identified files into separate groups by parameter-specific and parameter-independent groups; and
generating a separate package each of said separate groups of said identified files,
whereby separate parameter-specific and parameter-independent packages are generated.

26. A memory medium storing software code executable to perform the method of:
identifying the files desired to be downloaded and installed;
sorting said identified files into separate groups by parameter-specific and parameter-independent groups; and
generating a separate package each of said separate groups of said identified files,
whereby separate parameter-specific and parameter-independent packages are generated.
